(19) United States
(12) Patent Application Publication
(10) Pub. No.: US 2007/0146226 A1
(43) Pub. Date: Jun. 28, 2007

(54) EMBEDDED CHIP ANTENNA HAVING COMPLEMENTARY RADIATOR STRUCTURE

(75) Inventors: Jeong-Kun Oh, Shiheung-shi (KR); Young-Sang Yoon, Sungnam-shi (JP); Byung-Nam Kim, Pucheon-shi (KR); Seung-Yong Lee, Pucheon-shi (KR)

Correspondence Address: DITTHAVONG MORI & STEINER, P.C., 918 Prince St., Alexandria, VA, 22314, US

(73) Assignee: Ace Antenna Corp., Incheon-shi (KR)

(21) Appl. No.: 11/555,960

(22) Filed: Nov. 2, 2006

(30) Foreign Application Priority Data
Dec. 26, 2005 (KR) 10-2005-0129539

(51) Int. Cl. H01Q 1/40

(52) U.S. Cl. 343/873; 343/895

(57) ABSTRACT

Disclosed herein is an embedded chip antenna. The embedded chip antenna having a complementary radiator structure includes two radiators that have identical radiation characteristics and are respectively arranged on both sides of a feed point. According to the present invention, the radiator of a chip antenna has a single physical radiator structure, but is electrically formed of a plurality of partial radiators symmetrical with respect to a feed point, and radiation operations in high and low frequency bands are separately performed. Therefore, complementary operational characteristics that counteract external effects are implemented, so that, when part of a human body, such as the hand, affects one partial radiator on one side of the chip antenna, the other partial radiator on the other side thereof independently operates, thereby minimizing performance degradation originating from the outside of the antenna.

### BACKGROUND OF THE INVENTION

1. Field of the Invention

The present invention relates generally to an embedded chip antenna having a complementary radiator structure and, more particularly, to an embedded chip antenna in which dual partial radiators are arranged symmetrically, thereby having complementary characteristics.

2. Description of the Related Art

Currently, mobile communication terminals are being miniaturized and lightened, and, at the same time, are required to provide various types of services.

In order to satisfy this demand, internal circuits and elements used in mobile communication terminals are tending to become multi-functional, and, at the same time, to become gradually miniaturized.

Such a tendency is similarly applied to an antenna, which is one of the principal elements of a mobile communication terminal.

Antennas generally used for such mobile communication terminals include an external helical antenna, an internal Planar Inverted F Antenna (PIFA) and a chip antenna.

A helical antenna is an external antenna which is attached to the upper end of a mobile communication terminal, and is used along with a monopole antenna.

When an antenna, into which a helical antenna and a monopole antenna are integrated, is extended from the body of a mobile communication mobile, the antenna acts as the monopole antenna; and when the antenna is retracted, the antenna acts as a λ/4 helical antenna.

Such an antenna is advantageous in that it realizes a high gain, but is disadvantageous in that the Specific Absorption Rate (SAR), which is a measure of the influence of electromagnetic waves on the human body, is high because the antenna is non-directional.

In order to overcome the disadvantage, a PIFA or chip antenna having a low-profile structure is provided.

The PIFA and the chip antenna are internal antennas included in mobile communication terminals, so that the mobile communication terminals can be designed to have attractive appearances, and the antennas have a characteristic of being resistant to external impact.

The PIFA and the chip antennas are developed according to the trend of multifunction into dual band antennas each having dual radiators which are respectively responsible for different frequency bands, that is, a high frequency band and a low frequency band.

However, in the structures of a PIFA and a chip antenna, the antennas are affected by a user's finger or hand when the user is making a call, thereby degrading the performance of the antennas.

That is, when a PTFA or chip antenna is used in a mobile communication terminal, there are disadvantages in that the antenna is affected by the hand when a user holding the mobile communication terminal changes the location of his/her hand, thereby the telephone conversation is muted, and thus conversation becomes impossible.

### SUMMARY OF THE INVENTION

Accordingly, the present invention has been made keeping in mind the above problems occurring in the prior art, and an object of the present invention is to provide an embedded chip antenna having a complementary radiator structure which has the structure of double radiators arranged symmetrically with respect to the center thereof, thereby reducing the distortion and degradation of antenna characteristics caused by a user's body, and significantly improving call performance.

In order to accomplish the above object, the embedded chip antenna having a complementary radiator structure according to an embodiment of the present invention is characterized in that radiators having the same radiation characteristics are arranged on both sides of a feed point, thereby forming a chip antenna having a complementary radiator structure.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view of an embedded chip antenna according to a first embodiment of the present invention;

FIG. 2 is a perspective assembled view illustrating the embedded chip antenna of FIG. 1;

FIG. 3 is a perspective assembled view of an embedded chip antenna according to a second embodiment of the present invention;

FIG. 4 is a perspective view illustrating an example of the installation of the embedded chip antenna of FIG. 2;

FIG. 5 is a perspective assembled view of an embedded chip antenna according to a third embodiment of the present invention;

FIG. 6 is a perspective assembled view of an embedded chip antenna according to a fourth embodiment of the present invention;

FIG. 7 is a graph showing the standing-wave ratio of an embedded chip antenna according to an embodiment of the present invention; and

FIG. 8 is a graph showing standing-wave ratios in the case in which one end of the embedded chip antenna installed as in FIG. 4 is gripped by the hand.

### DESCRIPTION OF THE PREFERRED EMBODIMENTS

Reference now should be made to the drawings, in which the same reference numerals are used throughout the different drawings to designate the same or similar components.

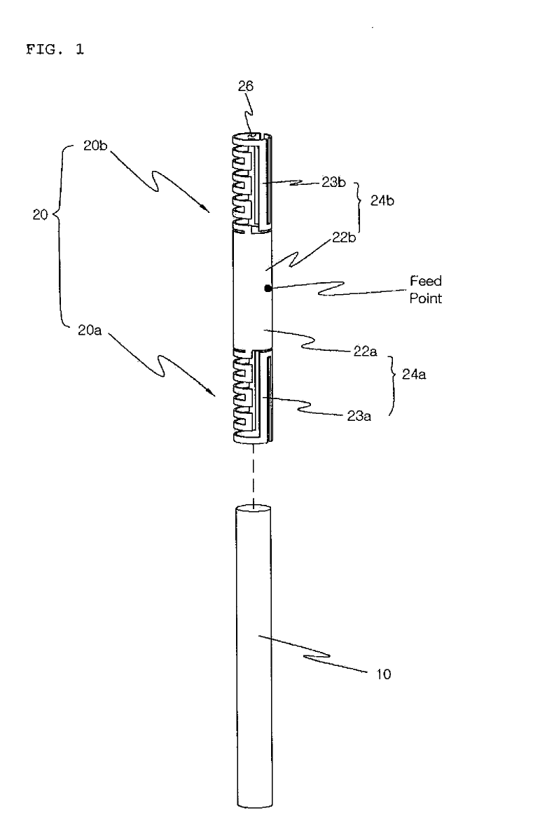

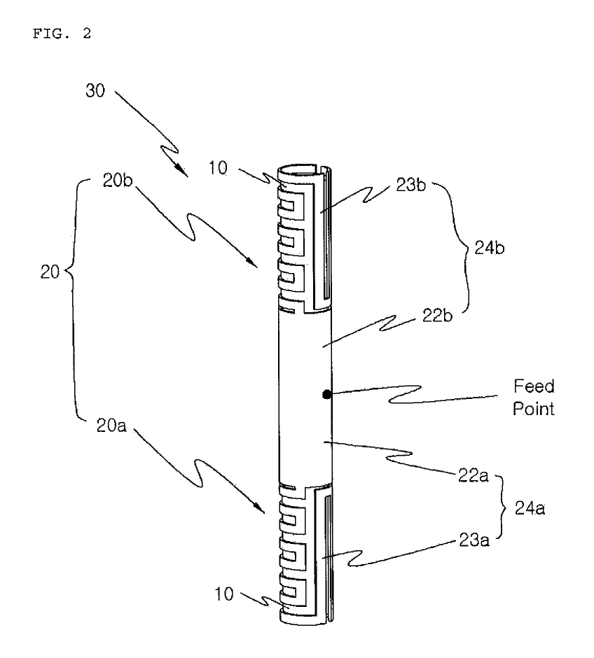

FIG. 1 is an exploded perspective view of an embedded chip antenna according to a first embodiment of the present invention, and FIG. 2 is a perspective assembled view illustrating the embedded chip antenna of FIG. 1.

Although, in the embodiments of the present invention, a chip antenna having dual-band characteristics will be described for convenience of description, it is also noted that the present invention can be applied to a chip antenna having single-band characteristics.

As illustrated in FIGS. 1 and 2, a radiator 20 includes first and second partial radiators 20a and 20b. That is, the first radiator 20a and the second radiator 20b, each of which includes a first radiation part 22a or 22b and a second radiation part 24a or 24b, are arranged symmetrically with respect to a feed point.

Each of the second radiation parts 24a and 24b includes the first radiation part 22a or 22b, and an extended radiation part 23a or 23b which extends from the first radiation part 22a or 22b.

Therefore, the radiator 20 has the shape of a cylinder having a longitudinal through hole 26, in which the first radiator 20a and the second radiator 20b, each of which includes the first radiation part 22a or 22b responsible for a high frequency band and the second radiation part 24a or 24b responsible for a low frequency band, are arranged symmetrically to each other.

The structure of radiator 20 has the shape of a hollow cylinder, the thickness of which is about 1 mm and the inside diameter of which is about 5 mm.

The extended radiation parts 23a and 23b, which respectively extend from the first radiation parts 22a and 22b, have meander line structures such that each of the second radiation parts 24a and 24b has an electrical length that can be responsible for a low frequency band.

The electrical length of the first radiation part 22a or 22b is a reference wavelength λₕ within a range of 0.03˜0.05 in a high frequency band, which is measured from the central feed point, and, more preferably, a reference wavelength λₕ of 0.04 in a high frequency band.

The entire electrical length of each of the second radiation parts 24a and 24b, each including the extended radiation part 23a or 23b having the meander line structure, which extends from an end of the first radiation part 22a or 22b, is a reference wavelength λ₁ within a range of 0.4˜0.6 in a low frequency band, which is measured from the central feed point, and, preferably, a reference wavelength λ₁ of 0.5 in a low frequency band.

The partial radiators 20a and 20b, that is, the first radiator 20a, which includes the first radiation part 22a and the second radiation part 24a on one side of the feed point, and the second radiator 20b, which includes the first radiation part 22b and the second radiation part 24b on the other side of the feed point, respectively and independently support high frequency and low frequency bands at the same time.

The the radiator 20, the first radiator 20a and the second radiator 20b are horizontally symmetrical with respect to the central feed point, and have a single feeding structure, so that first and second radiators operate independently, and thus are complementary.

The radiator 20 may further include a dielectric 10 which is embedded therein.

The dielectric 10 has a high dielectric constant, and is formed in a circular rod shape.

In the present invention, Liquid Crystal Polymer (LCP), which is plastic material having a high dielectric constant, is used as the dielectric 10.

The LCP is made of plastic material, the relative dielectric constant εᵣ of which is in a range of 7 to 13, which is physically similar to the relative dielectric constant of a ceramic chip antenna, but the heat resistant characteristic and mechanical strength of which are higher than those of the ceramic chip antenna.

The size of the chip antenna 30 can be reduced by embedding the dielectric 10 having a high dielectric constant in the radiator 20.

The first and second radiators 20a and 20b, which are partial radiators, are arranged symmetrically while the size of the radiators 20a and 20b is maintained at a chip size, thereby being complementary.

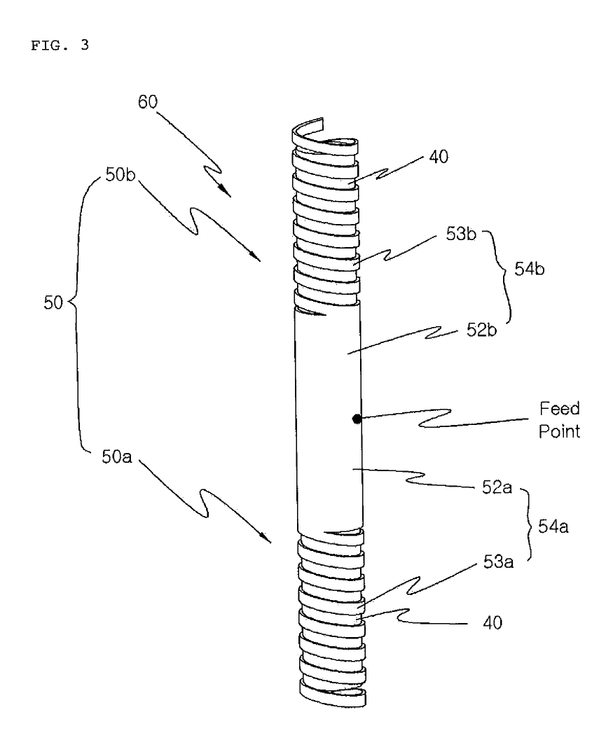

FIG. 3 is a perspective assembled view of an embedded chip antenna according to a second embodiment of the present invention.

As illustrated in FIG. 3, a radiator 50 includes first and second partial radiators 50a and 50b. That is, the first radiator 50a and the second radiator 50b, each of which includes a first radiation part 52a or 52b and a second radiation part 54a or 54b, are arranged symmetrically with respect to a feed point.

Each of the second radiation parts 54a and 54b includes the first radiation part 52a or 52b, and an extended radiation part 53a or 53b which extends from the first radiation part 52a or 52b.

Therefore, the radiator 50 has the shape of a cylinder having a longitudinal through hole, in which the first radiator 50a and the second radiator 50b, each of which includes the first radiation part 52a or 52b responsible for a high frequency band and the second radiation part 54a or 54b responsible for a low frequency band, are arranged symmetrically to each other.

The structure of radiator 50 has the shape of a hollow cylinder, the thickness of which is about 1 mm and the inside diameter of which is about 5 mm.

The extended radiation parts 53a and 53b, which respectively extend from the first radiation parts 52a and 52b, have helical-type structures such that each of the second radiation parts 54a and 54b has an electrical length that can be responsible for a low frequency band.

The electrical length of the first radiation part 52a or 52b is a reference wavelength λₕ within a range of 0.03˜0.05 in a high frequency band, which is measured from the central feed point, and, more preferably, a reference wavelength λₕ of 0.04 in a high frequency band.

The entire electrical length of each of the second radiation parts 54a and 54b, each including the extended radiation part 53a or 53b having the helical-type structure, which extends from an end of the first radiation part 52a or 52b, is a reference wavelength λ₁ within a range of 0.4˜0.6 in a low frequency band, which is measured from the central feed point, and, preferably, a reference wavelength (λ₁) of 0.5 in a low frequency band.

The partial radiators 50a and 50b, that is, the first radiator 50a, which includes the first radiation part 52a and the second radiation part 54a on one side of the feed point, and the second radiator 50b, which includes the first radiation part 52b and the second radiation part 54b on the other side of the feed point, respectively and independently support high frequency and low frequency bands at the same time.

In the radiator 50, the first radiator 50a and the second radiator 50b are horizontally symmetrical with respect to the central feed point, and have a single feeding structure, so that first and second radiators operate independently, and thus are complementary.

The radiator 50 may further include a dielectric 40 which is embedded therein.

The dielectric 40 has a high dielectric constant, and is formed in a circular rod shape.

In the present invention, LCP, which is plastic material having a high dielectric constant, is used as the dielectric 40.

The LCP is made of plastic material, the relative dielectric constant εᵣ of which is in a range of 7 to 13, which is physically similar to the relative dielectric constant of a ceramic chip antenna, but the heat resistant characteristic and mechanical strength of which are higher than those of the ceramic chip antenna.

The size of the chip antenna 60 can be reduced by embedding the dielectric 10 having a high dielectric constant in the radiator 50.

The first and second radiators 50a and 50b, which are partial radiators, are arranged symmetrically while the size of the radiators 50a and 20b is maintained at a chip size, thereby being complementary.

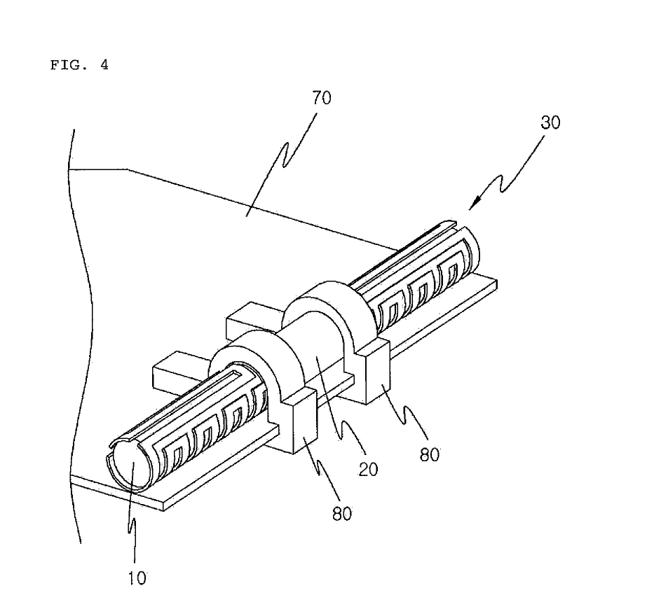

FIG. 4 is a diagram illustrating an example of the installation of the embedded chip antenna of FIG. 2, which illustrates the state in which the chip antenna 30 is fixedly installed in a Printed Wiring Board (PWB) using a fastener 80 when it is embedded in a mobile communication terminal.

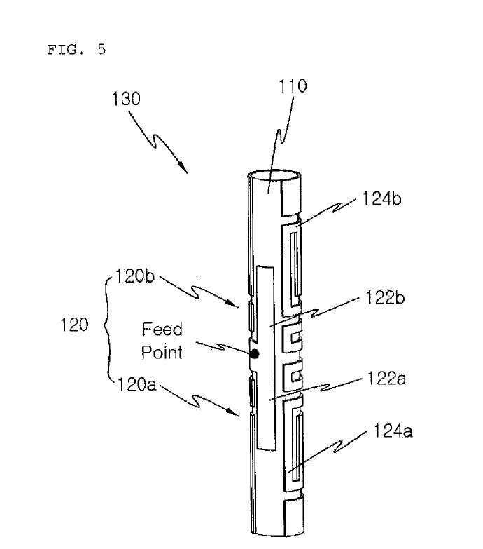

FIG. 5 is a perspective assembled view of an embedded chip antenna according to a third embodiment of the present invention.

The technical construction of the present embodiment is different from that of the first embodiment of FIG. 2 in that first radiation parts 122a and 122b responsible for high frequency bands are not cylindrical around a central feed point, and in that second radiation parts 124a and 124b do not respectively extend from the first radiation parts 122a and 122b, but are respectively separate from the first radiation parts 122a and 122b, and the second radiation parts 124a and 124b have meander line structures.

Since the structure in which partial radiators 120a and 120b are arranged symmetrically with respect to a feed point, the radiation parts 122a and 122b thereof are arranged symmetrically with respect to the feed point, and the radiation parts 124a and 124b thereof are arranged symmetrically with respect to the feed point and a dielectric 110 is embedded in a radiator 120 is identical to that of the first embodiment of FIG. 2, a description thereof is omitted here.

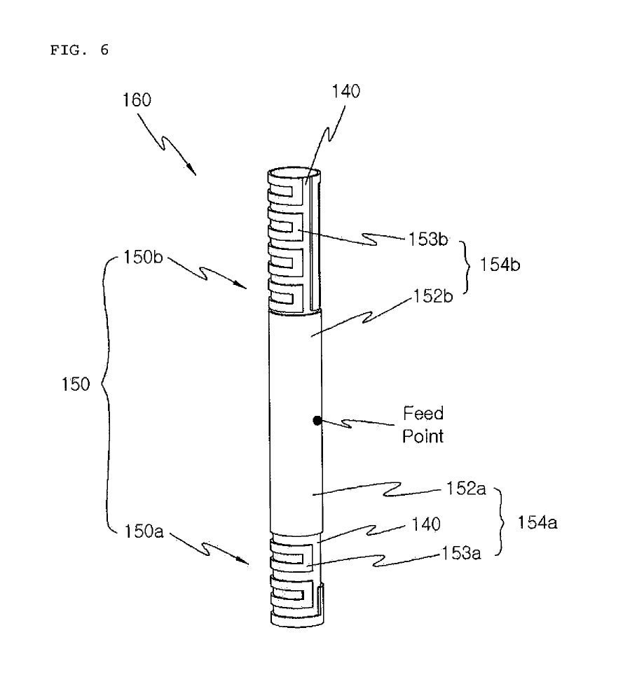

FIG. 6 is a perspective assembled view of an embedded chip antenna according to a fourth embodiment of the present invention.

The technical construction of the present embodiment is different from that of the first embodiment of FIG. 2 in that second radiation parts 154b, each of which includes a first radiation part 152a or 152b and an extended radiation part 153a or 153b and is responsible for a low frequency band, are arranged asymmetrically with respect to the feed point.

As illustrated in FIG. 6, when a radiation part is affected by the hand, a lower second radiation part 154a is formed to be shorter, and an upper second radiation part 154b is formed to be longer than the lower second radiation part 154a based on a phenomenon in which the resonant frequency shifts to a frequency band which is somewhat lower than the original resonant frequency.

As described above, when the second radiation parts 154a and 154b are formed to be asymmetrical to each other, the resonant frequency thereof shifts to a low frequency band, thereby obtaining characteristics identical to those of the upper second radiation part 154b when the lower second radiation part 154a is affected by the hand.

Since the structure in which the first radiation parts 152a and 152b, each of which is responsible for a high frequency band, are symmetrical to each other and a dielectric 140 is embedded in a radiator 150 is identical to that of the first embodiment of FIG. 2, a description thereof is omitted here.

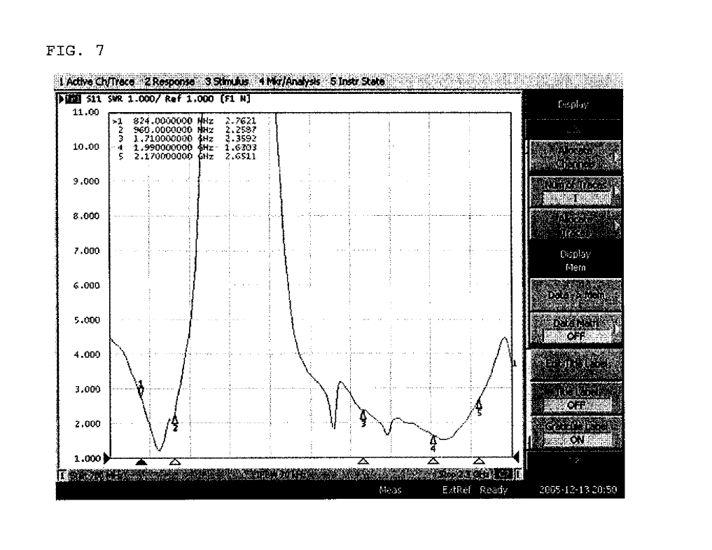

FIG. 7 is a graph illustrating the standing-wave ratio of an embedded chip antenna according to an embodiment of the present invention.

In the measurement results of the standing-wave ratios obtained in the state in which the chip antenna 30 is as illustrated in FIG. 4, the standing-wave ratios were low in the 0.8˜1.0 GHz band, which is a low frequency band, and in the 1.5˜2.2 GHz band, which is a high frequency band, as 5 illustrated in FIG. 7, and thus it can be known that excellent reflection loss characteristics exist.

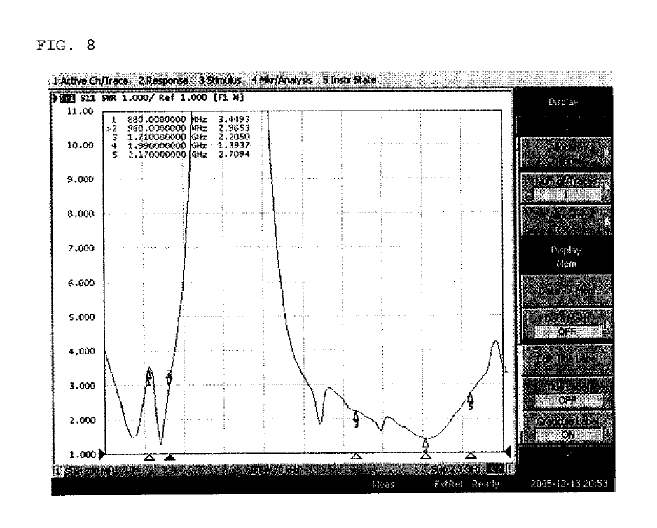

FIG. 8 is a graph illustrating standing-wave ratios in the case in which one end of the embedded chip antenna, installed as in FIG. 4, is held in both hands.

As illustrated in FIG. 8, it can be known that, in a high frequency range, the bandwidth thereof is wide and, therefore, variation thereof cannot be observed in detail. In contrast, in a low frequency range, when a partial radiator on one side of the chip antenna 30 is covered with the hand, the resonant frequency of the partial radiator covered with the hand is decreased due to the dielectric characteristics of the hand, and two resonance characteristics exist.

That is, it can be known that a partial radiator on the other side of the chip antenna 30, which is not covered with the hand, maintains its own original resonant frequency, and is not affected in the light of the radiation of electromagnetic energy.

Therefore, the experiments prove that the chip antenna 30 according to the present invention operates in a complementary manner when externally affected.

As described above, according to the present invention, the radiator of a chip antenna has a single physical radiator structure, but is electrically formed of a plurality of partial radiators symmetrical with respect to a feed point, and radiation operations in high and low frequency bands are separately performed. Therefore, complementary operational characteristics that counteract external effects are implemented, so that, when part of a human body, such as the hand, affects one partial radiator on one side of the chip antenna, the other partial radiator on the other side thereof independently operates, thereby minimizing performance degradation originating from the outside of the antenna.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An embedded chip antenna having a complementary radiator structure, comprising two radiators that have identical radiation characteristics and are respectively arranged on both sides of a feed point.

2. The embedded chip antenna as set forth in claim 1, wherein each of the radiators has a shape of a cylinder having a longitudinal through hole, and a dielectric having a relative high dielectric constant is inserted into the through hole.

3. The embedded chip antenna as set forth in claim 1, wherein each of the radiators comprises:
a first radiation part for performing radiation in a high frequency band; and
a second radiation part of performing radiation in a low frequency band.

4. The embedded chip antenna as set forth in claim 3, wherein the second radiation part comprises the first radiation part and an extended radiation part extended from the first radiation part.

5. The embedded chip antenna as set forth in claim 3, wherein each of the radiators has a shape of a cylinder having a longitudinal through hole, and a dielectric having a high relative dielectric constant is inserted into the through hole.

6. The embedded chip antenna as set forth in claim 5, wherein each of the extended radiation part and the second radiation part has a helical structure or a meander line structure.

7. The embedded chip antenna as set forth in claim 5, wherein the relative dielectric constant of the dielectric is within a range of 7˜13.

8. The embedded chip antenna as set forth in claim 5, wherein an electrical length of the first radiation part is a reference wavelength (λₕ) within a range of 0.03˜0.05 in a high frequency band, which is measured from the feed point.

9. The embedded chip antenna as set forth in claim 5, wherein an electrical length of the second radiation part is a reference wavelength (λ₁) within a range of 0.4˜0.6 in a low frequency band, which is measured from the feed point.

10. An embedded chip antenna having a complementary radiator structure, comprising a first radiator, having a first resonant frequency, and a second radiator, having resonant characteristics identical to those of the first radiator, due to change in resonant characteristics thereof for an external reason, such as an effect of a hand, the first and second radiators being respectively arranged on both sides of a feed point.
